(19) United States
(12) Patent Application Publication
(10) Pub. No.: US 2024/0199121 A1
(43) Pub. Date: Jun. 20, 2024

(54) METHOD FOR PRODUCING A DRIVABLE REGION FOR AN AT LEAST SEMI-AUTONOMOUSLY OPERATED MOTOR VEHICLE, COMPUTER PROGRAM PRODUCT, COMPUTER-READABLE STORAGE MEDIUM, AND ELECTRONIC COMPUTING DEVICE

(71) Applicant: VALEO SCHALTER UND SENSOREN GMBH, Bietigheim-Bissingen (DE)

(72) Inventors: Fabian Fuchs, Bietigheim-Bissingen (DE); Lasse Schnepel, Bietigheim-Bissingen (DE); Malte Joos, Bietigheim-Bissingen (DE)

(73) Assignees: VALEO SCHALTER UND SENSOREN GMBH, Bietigheim-Bissingen (DE); VALEO SCHALTER UND SENSOREN GMBH, Bietigheim-Bissingen (DE)

(21) Appl. No.: 18/287,986

(22) PCT Filed: Apr. 11, 2022
(86) PCT No.: PCT/EP2022/059569

§ 371 Date: Oct. 23, 2023

(30) Foreign Application Priority Data
Apr. 22, 2021 (DE) 10 2021 110 281.2

(51) Int. Cl. B62D 15/02; B60W 30/06; G01C 21/20; G01C 21/34

(52) U.S. Cl. CPC B62D 15/0285; B60W 30/06; G01C 21/206; G01C 21/3407

(57) ABSTRACT

The invention relates to a method for producing a drivable region (6) for an at least semi-autonomously operated motor vehicle (1), comprising the steps of: —specifying a drivable trajectory (10), which is formed by a trajectory point sequence (16); —specifying a first boundary (11), which is in the form of a first boundary point sequence (16), for a travel envelope (13), the first boundary having a first lateral distance (A1) from the drivable trajectory (10) and being formed on a first side of the drivable trajectory (10); —specifying a second boundary (12), which is in the form of a second boundary point sequence (17), for the travel envelope (13), the second boundary having a second lateral distance (A2) from the drivable 10 trajectory (10) and being formed on a second side of the drivable trajectory (10); and —producing the drivable region (6) by means of the drivable trajectory (10), the first boundary (11) and the second boundary (12). The invention also relates to a computer program product, to a computer-readable storage medium, and to an electronic computing device (5, 14).

The invention relates to a method for producing a drivable region for a region drivable for an at least semi-autonomously or fully autonomously operated motor vehicle.

Furthermore, the invention relates to a method for at least semi-autonomous operation of an at least semi-autonomously operated motor vehicle within an at least semi-autonomously drivable region, a computer program product, a computer-readable storage medium, and an electronic computing device.

Drivable regions for at least semi-autonomously operated motor vehicles or for fully autonomously operated motor vehicles are already known from the prior art. For this purpose, for example, drivable regions are specified which are produced on the basis of objects within the drivable region. These regions are often specified as polygons around these objects. In particular, the boundaries of the drivable region are therefore specified via corresponding polygons, in which the motor vehicle can then in turn move.

DE 10 2011 082 478 A1 discloses that by means of a simple 2D video system, a relative position in relation to predefined, fixedly attached markings within a reference system is detected and the images of the markings are studied with respect to distance and perspective. If the position of the markings within the reference system is known, self-localization of a vehicle can thus be implemented.

The object of the present invention is to provide a method, a computer program product, a computer-readable storage medium, and an electronic computing device, by means of which a drivable region for an at least semi-autonomously operated motor vehicle can be produced efficiently.

This object is achieved by a method, a computer program product, a computer-readable storage medium, and an electronic computing device according to the independent patent claims. Advantageous embodiments are specified in the dependent claims.

One aspect of the invention relates to a method for producing a drivable region for a region drivable for an at least semi-autonomously or fully autonomously operated motor vehicle. A drivable trajectory is specified which is formed by a trajectory point sequence. A first boundary is specified, which is formed as a first boundary point sequence, for a potentially usable driving tube having a first lateral distance to the drivable trajectory and is formed on a first side of the drivable trajectory. A second boundary is specified, which is formed as a second boundary point sequence, for the potentially usable driving tube having a second lateral distance to the drivable trajectory and is formed on a second side of the drivable trajectory opposite to the first side. The drivable region having the drivable trajectory, having the first boundary, and having the second boundary is produced as the potentially usable driving tube.

The drivable region for the motor vehicle can thus be generated in a resource-conserving and particularly efficient manner. In particular, for example, for this purpose the drivable region, for example in the form of a parking garage, can include an electronic computing device, which is designed for producing the drivable region, in particular for producing the potentially usable driving tube. In particular, an electronic map is produced as the drivable region. An electronic map is therefore produced in particular for the drivable region. A drivable trajectory is then specified, which is to be provided here in particular with specification of the ascertainment or calculation or determination of the drivable trajectory. An electronic map is to be understood in particular as a digital surroundings map, by means of which the motor vehicle can navigate at least semi-autonomously. The digital surroundings map comprises here in particular surroundings information with respect to objects, for example, houses and/or walls in the surroundings and roads or tracks or other drivable underlying surfaces for a motor vehicle.

In particular, the method can be used, for example, in order to carry out a journey through the drivable region, which can be carried out without satellite-assisted navigation, for example, GPS navigation. This is particularly advantageous should, for example, no corresponding GPS signal be receivable in the drivable region.

The drivable trajectory can then be specified as a curve. Furthermore, the first boundary and/or the second boundary can also be specified as a respective curve. Moreover, it can be provided that the drivable trajectory is specified in dependence on a vehicle center viewed in a main direction of travel of the motor vehicle.

In particular, the proposed invention thus overcomes the problem that boundaries or polygons according to the prior art are often large and do not include further information, so that it can be difficult, for example, for the motor vehicle to decide whether it is located on the correct side of these boundaries. By specifying the drivable trajectory, the first boundary, and the second boundary, a drivable driving tube is produced, so that the motor vehicle receives information about the side on which the motor vehicle moves or whether it moves correctly within the drivable region.

In particular, the drivable region, in particular as an electronic map of the drivable region, including the trajectory is therefore transmitted to the motor vehicle, wherein in this case an efficient approach is proposed which requires few memory and computing resources, in particular on the vehicle side. The electronic map or another map format for the drivable region to be transmitted to the motor vehicle is proposed, which in particular only includes a first curve or a first point sequence, which represents a theoretical trajectory for a motor vehicle, a second curve or a second point sequence, which represents a boundary of a drivable region of one side of the trajectory, and a third curve or a third point sequence, which represents a further boundary of the drivable region on the other side of the trajectory.

The motor vehicle in particular includes a corresponding assistance system, by means of which at least semi-autonomous operation, in particular fully autonomous operation is made possible. For this purpose, the assistance system can engage, for example, in a longitudinal acceleration device and/or a lateral acceleration device of the motor vehicle in order to be able to implement at least semi-autonomous operation or fully autonomous operation of the motor vehicle.

According to one advantageous embodiment, the drivable region is transmitted to the at least semi-autonomously or fully autonomously operated motor vehicle from a vehicle-external device. The vehicle-external device can in particular correspond here to the electronic computing device. For example, the drivable region can include the electronic computing device for this purpose and the electronic map can be transmitted to the motor vehicle, for example, upon entry into the drivable region. Therefore, upon entering the drivable region, the motor vehicle can navigate within the drivable region at least semi-autonomously, in particular fully autonomously.

In a further advantageous embodiment, a, in particular only one, boundary point of the first boundary point sequence and a, in particular only one, boundary point of the second boundary point sequence is assigned to each trajectory point of the trajectory point sequence. The potentially usable driving tube can therefore be produced and transmitted to the motor vehicle in a simple and resource-reduced manner. Navigation of the motor vehicle within the drivable region can therefore be implemented in a resource-conserving manner and with little computing capacity.

It has furthermore proved to be advantageous if a trajectory point and the boundary points assigned thereto, in particular on straight sections of the trajectory, lie on a line which runs perpendicular to the direction of travel. A driving tube can therefore be reliably produced, in which the motor vehicle can move. In particular, the production of the corresponding assigned boundary points therefore saves a large amount of computing capacity, since little computing effort is required to produce the corresponding boundary points perpendicular to the direction of travel.

In a further advantageous embodiment, an electronic map is provided for a drivable region designed as a parking region. For example, the parking region can be a parking region having so-called valet parking. In valet parking, it can be provided in particular that an occupant or user of the motor vehicle hands over the motor vehicle, for example, at an entry region of the parking region and then the motor vehicle is parked autonomously within the parking region. This is in particular very time-saving and convenient for the user. The motor vehicle can then in turn autonomously maneuver within the parking region. For example, for this purpose the motor vehicle can accordingly have a SLAM algorithm (self-localization and mapping), so that self-localization of the motor vehicle within the parking region is made possible.

It has furthermore proven to be advantageous if an electronic map is provided for a drivable region designed as a roofed parking garage. In particular in a parking garage, there is often no GPS signal present for the motor vehicle. On the basis of the electronic map or on the basis of the potentially usable driving tube within the drivable region, the roofed parking garage can now be reliably driven out of by means of self-localization of the motor vehicle. For this purpose it can be provided, for example, that the parking garage has corresponding landmarks or codes on walls of the parking garage, for example, on the basis of which the motor vehicle locates itself within the roofed parking garage in turn by detecting these landmarks or codes. Improved, at least semi-autonomous or fully autonomous driving of the motor vehicle within the roofed parking garage can thus be implemented.

It has furthermore proven to be advantageous if the first boundary is specified at a first lateral distance range to the drivable trajectory between 1.25 m and 1.75 m. Constant distances for the first boundary are specified in particular in straight, in particular in at least essentially straight, sections of the drivable trajectory.

In particular, the distance between the drivable trajectory and the first boundary and the second boundary can be in the specified ranges along at least 40%, or 50%, or 60%, or 70%, or 80%, or 90%, or 100% of the trajectory. In particular, the corresponding motor vehicle external dimensions can thus also be taken into consideration. The motor vehicle can then move freely within this region and, for example, freely evade objects or things. Targeted guidance of the motor vehicle within the drivable region and nonetheless also evasion of the motor vehicle in relation to objects in the potentially usable driving tube can thus be produced.

It is also advantageous if the second boundary is specified in a second lateral distance range to the drivable trajectory between 2 m and 2.75 m. Constant distances for the first boundary are specified in particular in straight, in particular in at least essentially straight, sections of the drivable trajectory.

It is also advantageous if the drivable trajectory and/or the first boundary and/or the second boundary are determined as a function of a specified dimension of the motor vehicle. For example, a standard dimension of a motor vehicle can be specified as a specified dimension. The motor vehicle can be described here, for example, using two, in particular using four circles. The motor vehicle can then be produced virtually via the two, in particular four circles, by which the potentially usable driving tube is in turn produced as a function thereof. In particular, for example, the drivable trajectory can be specified as a function of a vehicle center viewed in a main direction of travel of the standard motor vehicle. The electronic map can thus be produced for a large number of motor vehicles. For example, the standard dimension for the motor vehicles can be specified on the basis of averaging over a large number of motor vehicles. However, for example, a “worst-case” dimension can also be assumed, for example, a maximum dimension of motor vehicles for the drivable region can be used and the driving tube can be determined on this basis as the standard dimension, so that safe navigation in the drivable region can be implemented for all potential motor vehicles.

It is also advantageous if the drivable trajectory and/or the first boundary and/or the second boundary are determined as a function of the specific dimension of the motor vehicle. In particular, vehicle-specific dimension specifications of the motor vehicle can thus be taken into consideration. Safer operation of the specific motor vehicle within the drivable region can thus be implemented.

It has furthermore proven to be advantageous if the specific dimension is transmitted from the motor vehicle to a motor vehicle-external electronic computing device upon an entry of the motor vehicle into the drivable region. For example, the motor vehicle can transmit the corresponding dimension of the motor vehicle to the electronic computing device of the drivable region by means of a communication device. The drivable region or the motor vehicle-external electronic computing device then in turn determines the drivable trajectory, the first boundary, and the second boundary as a function of these transmitted dimension specifications of the motor vehicle. The potentially usable driving tube resulting therefrom is then in turn transmitted from the motor vehicle-external electronic computing device to the motor vehicle.

Furthermore, it has proven to be advantageous if the specific dimension is determined by means of a detection device of the drivable region upon an entry of the motor vehicle into the drivable region. In particular, the drivable region can include a camera, for example. Further sensors, such as a radar sensor device, an ultrasonic sensor device, or a lidar sensor device are also possible. The drivable region can then ascertain the dimension of the motor vehicle by means of the detection device. The drivable trajectory, the first boundary, and the second boundary are then determined within a motor vehicle-external electronic computing device of the drivable region as a function of this detected dimension. The potentially usable driving tube can then in turn be transmitted to the motor vehicle. The potentially usable driving tube can thus be produced in a motor vehicle-specific manner.

It has furthermore proven to be advantageous if the motor vehicle is localized in the drivable region. This can be carried out both by the drivable region itself and by the motor vehicle itself. For example, the motor vehicle can localize itself on the basis of corresponding detection devices in the motor vehicle. Alternatively or additionally, this can also take place on the basis of odometry data, for example. Furthermore, localization of the motor vehicle can be carried out by means of a camera in the drivable region or by means of further sensor devices. The position of the motor vehicle in the drivable region is thus known at all times.

It is also advantageous if the motor vehicle is localized in the drivable region on the basis of odometry data of the motor vehicle. In particular, for example, the odometry data can relate to a velocity and a steering wheel angle of the motor vehicle. The motor vehicle can therefore localize itself in the drivable region in a simple manner.

It is furthermore advantageous if the motor vehicle is localized in the drivable region on the basis of landmarks. In particular, these landmarks can be codes, for example. These landmarks or codes can then be detected by means of a camera or by means of a lidar sensor device of the motor vehicle. On the basis of this detection, localization of the motor vehicle can then in turn be carried out within the drivable region, in particular within the parking garage.

The invention also relates to a method for at least semi-autonomous operation of an at least semi-autonomously operated motor vehicle or an at least fully autonomously operated motor vehicle within an at least semi-autonomously drivable region. An electronic map having a drivable trajectory is received by the motor vehicle, wherein the drivable trajectory is transmitted with a first boundary and with a second boundary which delimit the potentially drivable driving tube. An individual travel trajectory of the motor vehicle is then determined as a function of the potentially drivable driving tube. In particular, semi-autonomous driving in a parking garage can thus be proposed. The parking garage can be designed, for example, as valet parking. In particular, it is provided that the motor vehicle plans an individual trajectory on the basis of a certain number of trajectory points and boundary points.

Furthermore, it has proven to be advantageous if an object in the potentially drivable driving tube is evaded autonomously by the motor vehicle within the driving tube. Should an object therefore be detected within the driving tube, for example, the motor vehicle can evade it independently. The motor vehicle thus plans an evasion trajectory within the drivable driving tube.

According to a further advantageous embodiment, potentially driving over the first boundary and/or the second boundary is carried out by the motor vehicle if a driving maneuver is not possible within the first and second boundary. In particular, this potential driving over is monitored. In particular, the surroundings can then be additionally detected and it can be checked, for example, whether, upon driving over the first boundary and/or the second boundary, safe navigation of the motor vehicle is also possible outside these boundaries. Therefore, for example, upon evasion in relation to an object, it is possible to reliably evade and navigate autonomously within the drivable region. In particular, after the evasion, the motor vehicle can again be maneuvered at least semi-autonomously in the driving tube.

The method presented is in particular a computer-implemented method. For this purpose it is provided in particular that a computer program product having program code means is provided which, when the program code means are processed on an electronic computing device, prompt it to carry out a method according to the preceding aspects. For this purpose, a further aspect of the invention relates to a computer-readable storage medium having the computer program product.

Still a further aspect of the invention relates to an electronic computing device that is designed to carry out a method according to the preceding aspects. In particular, the methods are carried out by means of the electronic computing device. For this purpose, the electronic computing device includes in particular circuits, in particular integrated circuits, processors, and further electronic components to be able to carry out a corresponding method. The electronic computing device can be provided internally in the motor vehicle and/or externally to the motor vehicle here. In particular, a system made up of the drivable region and the motor vehicle can thus be provided, which at least partially communicate with one another, for example, using the respective electronic computing devices.

Advantageous embodiments of the method are to be viewed as advantageous embodiments of the computer program product, the computer-readable storage medium, and the electronic computing device. The electronic computing device and the motor vehicle have concrete features for this purpose which enable the method or an advantageous embodiment thereof to be carried out.

Further features of the invention result from the claims, the figures, and the description of the figures. The features and combinations of features that are cited in the description above and also the features and combinations of features that are cited in the description of the figures below and/or shown in the figures alone can be used not only in the respectively indicated combination but also in other combinations without departing from the scope of the invention. The invention is therefore also intended to be considered to comprise and disclose embodiments that are not explicitly shown and explained in the figures but that result and can be generated from the explained embodiments, by way of separate combinations of features. Embodiments and combinations of features that therefore do not have all the features of an originally formulated independent claim should also be regarded as disclosed. Embodiments and combinations of features that go beyond or differ from the combinations of features set out in the back-references of the claims should furthermore be considered to be disclosed, in particular by the embodiments described above.

The invention will now be explained in more detail using preferred exemplary embodiments and with reference to the accompanying drawings.

### In the Figures:

FIG. 1 shows a schematic side view of a motor vehicle during an entry into a drivable region which is represented in particular as a parking garage; and

FIG. 2 shows a schematic top view of a drivable driving tube according to an embodiment of the method.

In the figures, identical or functionally identical elements are provided with the same reference signs.

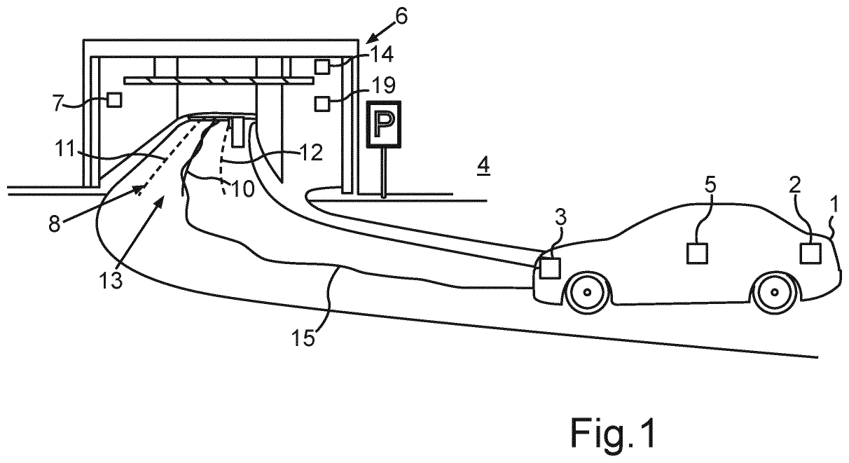

FIG. 1 shows a schematic side view of an embodiment of a motor vehicle 1. The motor vehicle 1 is designed to be at least semi-autonomous, in particular fully autonomous. For this purpose, the motor vehicle 1 can include an assistance system 2, which is designed for the at least semi-autonomous operation or fully autonomous operation of the motor vehicle 1. The assistance system 2 can engage, for example, in a longitudinal acceleration device and/or a lateral acceleration device of the motor vehicle 1 for autonomous operation. For this purpose, the assistance system 2 can include, for example, a detection device 3 for detecting the surroundings 4 of the motor vehicle 1. Furthermore, for example, the assistance system 2 can include an electronic computing device 5, which is in particular formed internally in the motor vehicle, for an evaluation.

Furthermore, FIG. 1 shows a drivable region 6. The drivable region 6 is designed in the present case in particular as a parking region. In the present case, the parking region or the drivable region 6 is designed in particular as a roofed parking garage. In particular, in the parking garage the motor vehicle 1 has no possibility of detecting a satellite-based position signal, for example, a GPS signal.

The drivable region 6 can include, for example, landmarks 7, which can be formed as codes, for example, so that the at least semi-autonomously operated motor vehicle 1 can localize itself within the drivable region 6. In the drivable region 6, in particular so-called valet parking can be provided. A user of the motor vehicle 1 can hand over the motor vehicle 1 upon entry 8 into the drivable region 6, for example, and subsequently thereto the motor vehicle 1 can be parked autonomously in the drivable region 6. In particular odometry data of the motor vehicle 1 can be used for navigating the motor vehicle 1 within the drivable region 6. Furthermore, the landmarks 7 can be used accordingly in the drivable region 6 in order to carry out a localization of the motor vehicle 1. Furthermore, localization can also be carried out, for example, by a so-called SLAM method (self-localization and mapping).

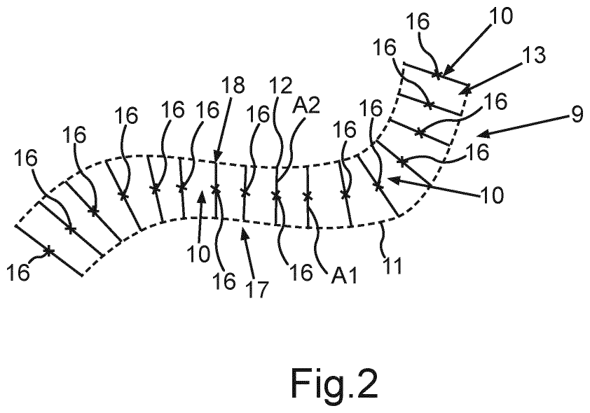

The invention therefore relates in one aspect to the autonomous operation of the at least semi-autonomously operated motor vehicle 1 within the drivable region 6. An electronic map 9 (FIG. 2) having a drivable trajectory 10, having a first boundary 11 and having a second boundary 12, which delimit a potentially drivable driving tube 13, is received. This can be carried out, for example, by a motor vehicle-external electronic computing device 14, for example, of the drivable region 6. An individual driving trajectory 15 of the motor vehicle 1 is then determined as a function of the potentially drivable driving tube 13. It can be provided here that an object in the potentially drivable driving tube 13 is evaded autonomously by the motor vehicle 1 within the driving tube 13. Furthermore, potentially driving over the first boundary 11 and/or the second boundary 12 can be carried out by the motor vehicle 1 if a driving maneuver is not possible within the first and second boundary 11, 12.

FIG. 2 shows a schematic top view of a produced driving tube 13 according to one embodiment of the method. FIG. 2 therefore in particular shows a method for producing the drivable region 6, in particular as a so-called electronic map 9, for the at least semi-autonomous or fully autonomous operation of the motor vehicle 1. The drivable trajectory 10, which is formed by a trajectory point sequence 16, is specified. The first boundary 11, which is formed as a first boundary point sequence 17, for the potentially usable driving tube 13 is specified having a first lateral distance A1 to the drivable trajectory 10 on a first side of the drivable trajectory 10. The second boundary 12, which is formed as a second boundary point sequence 18, for the potentially usable driving tube 13 is specified having a second lateral distance A2 to the drivable trajectory 10 and on a second side of the drivable trajectory 10 opposite to the first side. The drivable region 16 or the electronic map 9 having the drivable trajectory 10, having the first boundary 11 and having the second boundary 12 is produced as the potentially usable driving tube 13.

The drivable region 6, in particular the electronic map 9, is transmitted in particular from a vehicle-external device, in the present case, for example, the motor vehicle-external electronic computing device 14, to the motor vehicle 1.

As FIG. 2 shows, a, only one, boundary point of the first boundary point sequence 17 and a, in particular only one, boundary point of the second boundary point sequence 18 can be assigned to each trajectory point of the trajectory point sequence 16. A trajectory point and the boundary points assigned thereto, in particular on straight sections of the trajectory 10, will lie on a line which runs perpendicular to the direction of travel.

It can be provided, for example, that the first boundary 11 is specified in a first lateral distance range A1 to the drivable trajectory between 1.25 m and 1.75 m. The second boundary 12 can be specified in a second lateral distance range A2 to the drivable trajectory 10 between 2 m and 2.75 m.

Furthermore, it can be provided that the drivable trajectory 10 and/or the first boundary 11 and/or the second boundary 12 are determined as a function of the specific dimension of the motor vehicle 1. The specific dimension can be transmitted, for example, upon the entry 8 of the motor vehicle 1 into the drivable region 6 from the motor vehicle 1 to the motor vehicle-external electronic computing device 14. Alternatively, the specific dimension can be determined upon the entry 8 of the motor vehicle 1 into the drivable region 6 by means of a detection device 19 of the drivable region 6. In a further alternative, a specified dimension of the motor vehicle 1 can also be specified, for example, as a standard dimension for the motor vehicle 1.

In particular, the electronic map 9 is thus proposed as the drivable region 6, which in particular relates to a parking garage. The electronic map 9 is transmitted to the motor vehicle 1, which in particular only comprises the drivable trajectory 10, the first boundary 11, and the second boundary 12. The trajectory 10 is in particular solely a point sequence. The first boundary 11 is furthermore also a point sequence. The second boundary 12 is also solely a point sequence. The distance between the trajectory 10 and the first boundary 11 is in particular between 1.25 and 1.75 m. The distance between the trajectory 10 and the second boundary 12 is, for example, between 2 m and 2.75 m. The distances can be in the specified ranges along at least 40%, 50%, 60%, 70%, 80%, 90%, or 100% of the trajectory 10.

In particular, it can be provided that the motor vehicle 1 plans an individual trajectory 15 within a certain number of trajectory points and boundary points. It can then be provided that should an obstacle be detected, for example, the motor vehicle 1 then plans an evasion trajectory within the drivable region, thus within the driving tube 13. A collision is checked here between the boundaries 11, 12 and the motor vehicle 1.

1. A method for producing a drivable region for a region drivable for an at least semi-autonomously or fully autonomously operated motor vehicle, the method comprising:
specifying a drivable trajectory, which is formed by a trajectory point sequence;
specifying a first boundary, which is formed as a first boundary point sequence, for a potentially usable driving tube comprising a first lateral distance to the drivable trajectory and which is formed on a first side of the drivable trajectory;
specifying a second boundary, which is formed as a second boundary point sequence, for the potentially usable driving tube comprising a second lateral distance to the drivable trajectory and which is formed on a second side of the drivable trajectory opposite to the first side; and
producing the drivable region comprising the drivable trajectory, the first boundary, and having the second boundary as the potentially usable driving tube.

2. The method as claimed in claim 1,
wherein the drivable region is transmitted to the at least semi-autonomously or fully autonomously operated motor vehicle from a vehicle-external device.

3. The method as claimed in claim 1,
wherein a, boundary point of the first boundary point sequence and a boundary point of the second boundary point sequence is assigned to each trajectory point of the trajectory point sequence.

4. The method as claimed in claim 1, wherein a trajectory point and the boundary points assigned thereto lie on a line which runs perpendicular to the direction of travel of the motor vehicle.

5. The method as claimed in claim 1, wherein an electronic map is provided for a drivable region designed as a parking region.

6. The method as claimed in claim 1, wherein an electronic map is provided for a drivable region designed as a roofed parking garage.

7. The method as claimed in claim 1, wherein the first boundary is specified in a first lateral distance range to the drivable trajectory between 1.25 m and 1.75 m.

8. The method as claimed in claim 1, wherein the second boundary is specified in a second lateral distance range to the drivable trajectory between 2 m and 2.75 m.

9. The method as claimed in claim 1, wherein the drivable trajectory, the first boundary, and the second boundary are determined as a function of a specified dimension of the motor vehicle.

10. The method as claimed claim 1,
wherein the drivable trajectory, and/or the first boundary, and the second boundary are determined as a function of a specific dimension of the motor vehicle.

11. The method as claimed in claim 10,
wherein the specific dimension is transmitted upon an entry of the motor vehicle into the drivable region from the motor vehicle to a motor vehicle-external electronic computing device.

12. The method as claimed in claim 10,
wherein the specific dimension is determined upon an entry of the motor vehicle into the drivable region by means of a detection device of the drivable region.

13. The method as claimed in claim 1,
characterized in that wherein the motor vehicle is localized in the drivable region.

14. The method as claimed in claim 13,
wherein the motor vehicle is localized in the drivable region on the basis of odometry data of the motor vehicle.

15. The method as claimed in claim 13, characterized in that wherein the motor vehicle is localized in the drivable region on the basis of landmarks in the drivable region.

16. A method for at least semi-autonomous operation of an at least semi-autonomously operated motor vehicle within an at least semi-autonomously drivable region, the method comprising:
receiving an electronic map comprising a drivable trajectory, a first boundary, and a second boundary, which delimit a potentially drivable driving tube; and
determining an individual driving trajectory of the motor vehicle as a function of the potentially drivable driving tube.

17. The method as claimed in claim 16,
wherein an object in the potentially drivable driving tube is evaded autonomously by the motor vehicle within the driving tube.

18. The method as claimed in claim 16,
wherein potentially driving over the first boundary and the second boundary is carried out by the motor vehicle when a driving maneuver is not possible within the first boundary and second boundary.

19. A non-transitory computer readable medium containing program instructions for causing a processor to perform the method of claim 1.

20. (canceled)

21. An electronic computing device, which is designed to carry out a method as claimed in claim 1.
